(19) United States
(12) Patent Application Publication
(10) Pub. No.: US 2003/0008689 A1
(43) Pub. Date: Jan. 9, 2003

(54) Wireless portable terminal device, method of amplifying received voices and program for the same

(76) Inventor: Yoshihide Uda, Shizuoka (JP)

Correspondence Address: McGinn & Gibb, PLLC, Suite 200, 8321 Old Courthouse Road, Vienna, VA, 22182-3817, US

(21) Appl. No.: 10/185,043

(22) Filed: Jul. 1, 2002

(30) Foreign Application Priority Data
Jul. 3, 2001 (JP) 202512/2001

(51) Int. Cl. H04M 1/00

(52) U.S. Cl. 455/569; 455/568

(57) ABSTRACT

In a wireless portable terminal device having a structure that an operator can perform voice communication when the device is in a folded status and can perform key operations while watching a display unit when the device is in an unfolded status, the invention provides the operator with the easiest-to-handle and most convenient wireless portable terminal device, together with a method of amplifying received voices and a program thereof.

### BACKGROUND OF THE INVENTION

1. Field of the Invention

This invention relates to a wireless portable terminal device in which paths of received voices are switched in accordance with a status of the device, a method of amplifying received voices and a program thereof.

2. Description of Related Art

A conventional wireless portable terminal device includes a voice-receiving receiver inside a casing thereof, and received voices are solely outputted to the voice-receiving receiver. Therefore, a user needs to put the ear on the wireless portable terminal to listen to the received voices. The structures of wireless portable terminal devices include various types such as a solid type and a folding type. Although it is no wonder in the solid type, the user also needs to unfold the folding-type wireless portable terminal device normally upon voice communication and to put the ear on the voice-receiving receiver to listen to received voices.

A wireless portable terminal device in recent years is not just satisfied with a function as the telephone, but is required to display large-scale information on a network or to display a database stored in the device itself such as telephone numbers onto a display unit of the device, in order to offer more opportunities for an operator to communicate while watching the display unit.

Moreover, there are network services recently initiated, in which a user is required to operate operating portions (such as numeric keypads) of a wireless portable terminal device while listening to guidance from the network so as to transmit necessary information to the network.

As described, a character of a wireless portable terminal device, which has been principally used for voice communication, is more strengthened as an information communication terminal to have access to the network (such as the Internet). In this context, a demand for a larger display unit (a liquid crystal display) is increasing.

Meanwhile, in order to maintain portability as a mobile instrument, a demand for downsizing a casing of a wireless portable terminal device is also increasing. To meet the foregoing two demands, it is effective to design the casing into a folding type, and the folding type is widespread accordingly.

A conventional wireless portable terminal device had a problem that a user had to take the ear off the device when the user spoke while watching a display unit or when the user needed to operate operating portions while listening to received voices, whereby the user could not listen to the voices from an opponent.

In order to solve such a problem, Japanese Unexamined Patent Publication 2000-244631 (laid open on Sep. 8, 2000) discloses a technology, in which a discrete amplifying loudspeaker is provided and the path of received voices is switched to by extracting the amplifying loudspeaker out of a casing when a user wishes to output amplified received voices from the amplifying loudspeaker. As a result, the user can listen to voices of an opponent if the user put the ear off a wireless portable terminal device.

Moreover, Japanese Unexamined Patent Publications 2001 —061004 (laid open on Mar. 6, 2001), 11 (1999)—289290 (laid open on Oct. 19, 1999), 11 (1999)—308166 (laid open on Nov. 5, 1999) and 11 (1999)—317701 (laid open on Nov. 16, 1999) disclose technologies for selectively controlling voice output modes between a normal output mode and a hand-free mode (an extended loudspeaker mode) depending on various changes of statuses or on user setting.

Nevertheless, any of the above-mentioned publications are not concerning a terminal having a folding-type casing. Accordingly, none of the above technologies deem folded and unfolded statuses of a casing as parameters of status changes.

### SUMMARY OF THE INVENTION

The present invention provides a wireless portable terminal device capable of amplifying received voices in accordance with folded and unfolded statuses of a casing. The wireless portable terminal device according to the present invention has a structure enabling voice communication when the casing is folded as well as key operation while watching a display unit when the casing is unfolded. The invention provides an operator of the wireless portable terminal device of the foregoing structure with the easiest-to-handle and most convenient wireless portable terminal device, a method of amplifying received voices and a program thereof, by means of detecting folding and unfolding actions of the device and thereby amplifying received voices automatically.

To be more precise, an aspect of the present invention is a wireless portable terminal device of a folding type provided with a voice-receiving receiver for outputting received voices, and an amplifying loudspeaker for outputting amplified received voices. Here, the wireless portable terminal device is designed in a manner that a casing is foldable and unfoldable, in which normal voice communication is performed in a folded status and voice communication and/or an operation of an application is performed in an unfolded status. The wireless portable terminal device includes folding status detecting means for detecting a folding status of the casing, and controlling means for switching a destination of output of the received voices automatically in accordance with the folding status detected by the folding status detecting means. Further, the controlling means outputs the received voices to the amplifying loudspeaker when a result of detection by the folding status detecting means is the unfolded status and outputs the received voices to the voice-receiving receiver when the result of detection is the folded status.

Another aspect of the invention is a wireless portable terminal device of a folding type provided with a voice-receiving receiver, the wireless portable terminal device being designed in a manner that a casing is foldable and unfoldable, in which normal voice communication is performed in a folded status and voice communication and/or an operation of an application is performed in an unfolded status. Here, the wireless portable terminal device includes folding status detecting means for detecting a folding status of the casing, and controlling means for varying an amplification factor of received analog signals automatically in accordance with the folding status detected by the folding status detecting means. For example, the controlling means sets amplification factors of the received voices to an amplification factor for voice amplification when a result of detection by the folding status detecting means is the unfolded status and to an amplification factor for voice-receiving when the result of detection is the folded status. Here, the amplification factor for voice amplification is set higher than the amplification factor for voice-receiving.

Another aspect of the present invention is the wireless portable terminal device further including a hands-free headset connector for connecting a hands-free headset, and hands-free headset connection detecting means for detecting as to whether a hands-free headset is connected to the hands-free headset connector. Here, the controlling means outputs the received voices to the hands-free headset connector when connection of the hands-free headset to the hands-free headset connector is detected by the hands-free headset connection detecting means. Further, another aspect of the invention is the wireless portable terminal device further including mute processing means for canceling echoes automatically upon amplifying the received voices.

Still another aspect of the invention is a method of amplifying received voices in a wireless portable terminal device of a folding type provided with a voice-receiving receiver for outputting received voices and an amplifying loudspeaker for outputting amplified received voices. Here, the wireless portable terminal device is designed in a manner that a casing is foldable and unfoldable, in which normal voice communication is performed in a folded status and voice communication and/or an operation of an application is performed in an unfolded status. The method includes a folding status detecting step of detecting a folding status of the casing, and a switching step of switching a destination of output of the received voices automatically in accordance with the folding status detected by the folding status detecting step. Specifically, in the switching step, the received voices are outputted to the amplifying loudspeaker when a result of detection in the folding status detecting step is the unfolded status, and the received voices are outputted to the voice-receiving receiver when the result of detection in the folding status detecting step is the folded status.

Another aspect of the invention is a method of amplifying received voices for a wireless portable terminal device of a folding type provided with a voice-receiving receiver, the wireless portable terminal device being designed in a manner that a casing is foldable and unfoldable, in which normal voice communication is performed in a folded status and voice communication and/or an operation of an application is performed in an unfolded status. Here, the method includes a folding status detecting step of detecting a folding status of the casing, and a switching step of varying an amplification factor of received analog signals automatically in accordance with the folding status detected by the folding status detecting means. The switching step switches amplification factors of the received voices to an amplification factor for voice amplification when a result of detection by the folding status detecting means is the unfolded status and to an amplification factor for voice-receiving when the result of detection is the folded status. Another aspect of the invention is the method of amplifying received voices further including a hands-free headset connection detecting step of detecting as to whether a hands-free headset is connected to a hands-free headset connector. Here, the switching step outputs the received voices to the hands-free headset connector when connection of the hands-free headset to the hands-free headset connector is detected by the hands-free headset connection detecting step. Moreover, the switching step closes a path for the received voices during stand-by and during data communication.

Yet another aspect of the invention is a program for executing an operation of amplifying received voices in a wireless portable terminal device of a folding type provided with a voice-receiving receiver for outputting received voices and an amplifying loudspeaker for outputting amplified received voices. Here, the wireless portable terminal device is designed in a manner that a casing is foldable and unfoldable, in which normal voice communication is performed in a folded status and voice communication and/or an operation of an application is performed in an unfolded status. The program causes the wireless portable terminal device to execute a folding status detecting procedure for detecting a folding status of the casing, and a switching procedure for switching a destination of output of the received voices automatically in accordance with the folding status detected in the folding status detecting procedure. Moreover, in the switching procedure, the received voices are outputted to the amplifying loudspeaker when a result of detection in the folding status detecting procedure is the unfolded status, and the received voices are outputted to the voice-receiving receiver when the result of detection is the folded status.

Another aspect of the invention is a program for executing an operation of amplifying received voices in a wireless portable terminal device of a folding type provided with a voice-receiving receiver, the wireless portable terminal device being designed in a manner that a casing is foldable and unfoldable, in which normal voice communication is performed in a folded status and voice communication and/or an operation of an application is performed in an unfolded status. Here, the program causes the wireless portable terminal device to execute a folding status detecting procedure for detecting a folding status of the casing, and a switching procedure for varying an amplification factor of received analog signals automatically in accordance with the folding status detected in the folding status detecting procedure. The switching procedure sets amplification factors of the received voices to an amplification factor for voice amplification when a result of detection in the folding status detecting procedure is the unfolded status and to an amplification factor for voice-receiving when the result of detection is the folded status. Another aspect of the invention is the program further causing the wireless portable terminal device to execute a hands-free headset connection detecting procedure for detecting as to whether a hands-free headset is connected to a hands-free headset connector. Here, the switching procedure outputs the received voices to the hands-free headset connector when connection of the hands-free headset to the hands-free headset connector is detected in the hands-free headset connection detecting procedure. Moreover, the switching procedure closes a path for the received voices during stand-by and during data communication.

### BRIEF DESCRIPTION OF THE DRAWINGS

The above and other objects, features and advantages of the present invention will become more apparent from the following detailed description when taken in conjunction with the accompanying drawings wherein:

FIG. 1 is a perspective view showing one structural example of a wireless portable terminal device according to the present invention;

FIG. 2 is another perspective view showing one structural example of the wireless portable terminal device according to the present invention;

FIG. 3 is a state transition diagram showing operations of a method of amplifying received voices according to the present invention upon detection of a folding status;

FIG. 4 is a block diagram showing a constitution of a wireless portable terminal device according to a first embodiment of the present invention;

FIG. 5 is a block diagram showing a constitution of a wireless portable terminal device according to a second embodiment of the present invention; and

FIG. 6 is a block diagram showing a constitution of a wireless portable terminal device according to a third embodiment of the present invention.

### DETAILED DESCRIPTION OF THE PREFERRED EMBODIMENTS

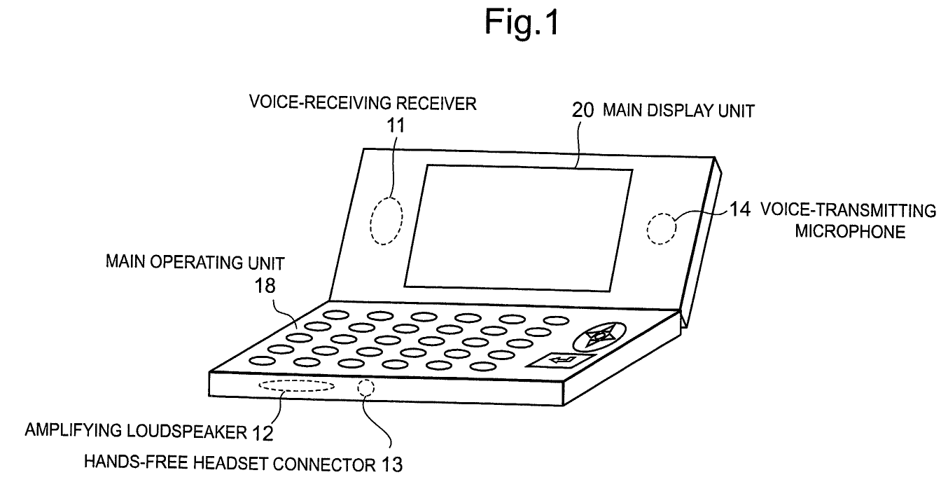

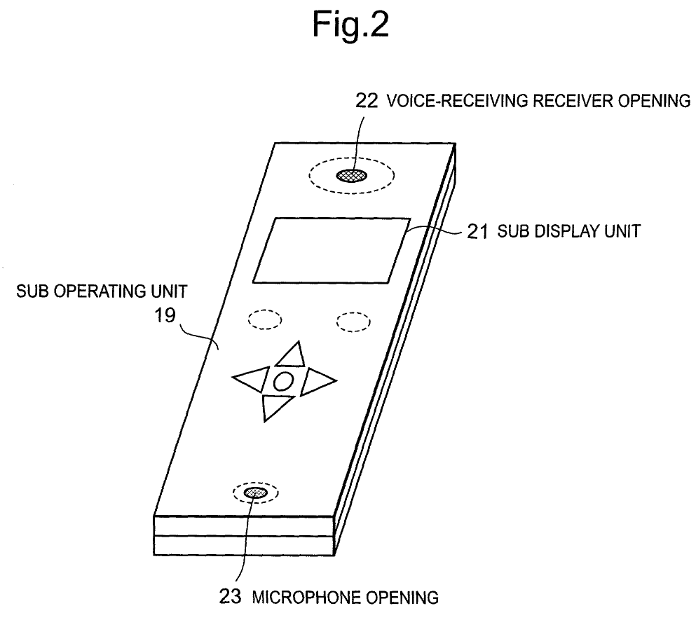

FIG. 1 and FIG. 2 are perspective views showing a structure of a wireless portable terminal device according to a first embodiment of the present invention. FIG. 1 is a perspective view showing an example of the device in an unfolded status. A voice-receiving receiver 11, a main display unit 20 and a voice-transmitting microphone 14 are loaded on an upper cover of the device. A main operating unit 18, an amplifying loudspeaker 12 and a hands-free headset connector 13 are loaded on a lower cover thereof. As shown in FIG. 1, the main display unit 20 and the main operating unit 18 are usable in the unfolded status of the device. Moreover, received voices are amplified by the amplifying loudspeaker 12, whereby an operator can listen to the received voices if the operator puts the ear off the device.

FIG. 2 is a view showing one example of the device in a folded status. A voice-receiving receiver opening 22, a sub display unit 21, a sub operating unit 19 and a microphone opening 23 are loaded on an outer surface of a casing of the device. The sub display 21 and the sub operating unit 19, which are minimally required for transmission or reception, are usable. The received voices are outputted from the voice-receiving receiver opening 22, whereby the operator can talk while putting the ear onto the device.

Although the embodiment shows an example in which the casing is unfoldable along a longitudinal side of the device, the casing may be also designed to be unfoldable along a lateral side thereof or slidable along the longitudinal or the lateral side thereof.

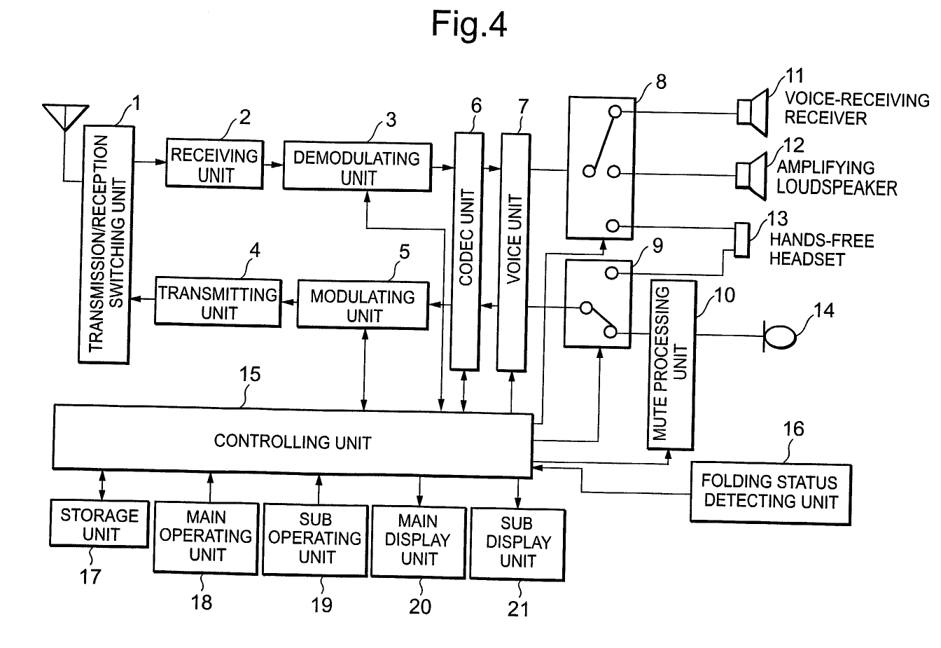

FIG. 4 is a block diagram showing a constitution of the wireless portable terminal device according to the embodiment. A transmission/reception switching unit 1 switches a transmission path between a path from an antenna to a receiving unit 2 and a path from a transmitting unit 4 to the antenna. Incoming wireless signals are received by the receiving unit 2 and demodulated into digital signals by a demodulating unit 3. The demodulated digital signals are converted into analog voice signals by a codec unit 6 and outputted to a voice unit 7.

The voice unit 7 has a function to amplify the analog voice signals by appropriate amplification factors in accordance with each event of using the voice-receiving receiver (when the casing is folded), using the amplifying loudspeaker (when the casing is unfolded) and connecting a hands-free headset, on the basis of instructions by a controlling unit 15. The voice unit 7 outputs the analog voice signals amplified in accordance with the instructions from the controlling unit 15 to a received-voice switching unit 8. The received-voice switching unit 8 selects the destination of output instructed by the controlling unit 15 and outputs the analog voice signals from the voice unit 7 to the relevant destination.

The voice-receiving receiver 11 is used upon ordinary talk, that is, for outputting the received voices in the event of ordinary talk in the folded status. The amplifying loudspeaker 12 is normally used for outputting an amplified sound such as a ring tone, but the amplifying loudspeaker 12 is also used for amplifying the received voices. The hands-free headset connector 13 can input and output analog voice signals when a hands-free headset is connected thereto.

Meanwhile, transmitting voices have two types, namely, a case where analog voice signals are collected with the voice-transmitting microphone 14 and a case where analog voice signals from the hands-free headset connector 13 when the hands-free headset is connected. The analog signals collected with the voice-transmitting microphone 14 are outputted to a transmitting-voice switching unit 9.

In the event of amplifying the received voices, it is concerned that the amplified received voices from the amplifying loudspeaker 12 are taken into the transmitting voices through the voice-transmitting microphone 14 to cause acoustic feedback. To avoid this, a mute processing unit 10 stops outputting the transmitting voices when the received voices are amplified.

The transmitting-voice switching unit 9 selects either the analog voice signals from the voice-transmitting microphone 14 or the analog voice signals from the hands-free headset connector 13 in accordance with instructions from the controlling unit 15, and outputs the selected signals to the voice unit 7. The voice unit 7 amplifies the selected analog voice signals by an appropriate amplification factor for the case of using the voice-transmitting microphone or the case of connecting the hands-free headset in accordance with instructions from the controlling unit 15. Then, the voice unit 7 outputs the analog voice signals to the codec unit 6. The codec unit 6 codes the analog voice signals into digital signals and outputs the digital signal. The digital signals are modulated into transmitting-voice wireless digital signals by a modulating unit 5 and transmitted from the antenna via the transmitting unit 5 and the transmission/reception switching unit 1.

The controlling unit 15 controls the entire device. The controlling unit 15 is connected to the voice unit 7, the received-voice switching unit 8, the transmitting-voice switching unit 9, the mute processing unit 10, a storage unit 17, the main operating unit 18, the sub operating unit 19, the main display unit 20, the sub operating unit 21 and a folding status detecting unit 16 in order to perform control of the device.

The storage unit 17 stores a variety of status information such as a folding status of the casing, a status of hands-free headset connection and a status of talk or communication. The main display unit 20 displays databases such as large-scale information on a network or telephone numbers stored in the device. The main operating unit 18 is required for effectuating transmission of necessary information to the network or executing operations to cause the display as described above. The sub display unit 21 performs the minimum requisite display for normal transmission or reception. The sub operating unit 19 includes the minimum requisite operational functions for normal transmission and reception. The folding status detecting unit 16 detects the folding status of the casing.

As the wireless portable terminal device, the embodiment is applicable to a cellular telephone, a personal handy-phone system (a PHS), a personal digital assistant (a PDA), and the like.

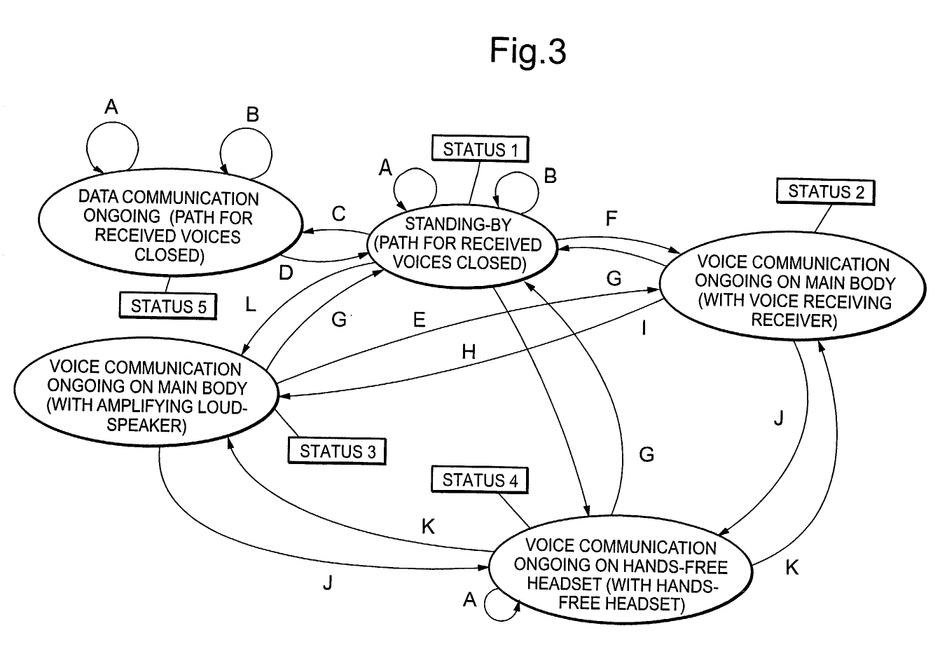

Next, operations in the embodiment will be described with reference to FIG. 3. Characters used in FIG. 3 are defined as below.

A: FOLDING OPERATION

B: HANDS-FREE HEADSET INSERTING/EXTRACTING OPERATION

C: INITIATE DATA COMMUNICATION

D: TERMINATE DATA COMMUNICATION

E: HANDS-FREE HEADSET CONNECTED INITIATE VOICE COMMUNICATION

F: FOLDED STATUS/HANDS-FREE HEADSET UNCONNECTED INITIATE VOICE COMMUNICATION

G: TERMINATE VOICE COMMUNICATION

H: UNFOLDED STATUS→FOLDED STATUS

I: FOLDED STATUS→UNFOLDED STATUS

J: HANDS-FREE HEADSET CONNECTED

K: FOLDED STATUS/HANDS-FREE HEADSET UNCONNECTED

L: UNFOLDED STATUS/HANDS-FREE HEADSET UNCONNECTED

FIG. 3 is a view showing one example of state transition (operations in a method of amplifying received voices depending on detection of the folding status) of the wireless portable terminal device according to the first embodiment of the present invention.

When any talk or communication does not take place, the wireless portable terminal device upon detection of the folding status is in a stand-by status (hereinafter referred to as Status 1), and a path for received voices are closed therein. In Status 1, when the folding status detecting unit 16 detects a change of the folding status or when the hands-free headset connector 13 detects an operation of inserting or extracting the hands-free headset, the controlling unit 15 just stores such a status change in the storage unit 17 but does not change the path for received voices.

In Status 1, when a condition for initiating data communication arises, the controlling unit 15 allows the status to transit from the stand-by status to a data-communicating status (hereinafter referred to as Status 5). Since voice transmission does not take place in Status 5, the path for received voices remains closed as similar to Status 1. In the event of data communication, transmitting data signals are transferred from the controlling unit 15 to the modulating unit 5 and received data signals are transferred from the demodulating unit 3 to the controlling unit 15. The controlling unit 15 performs data processing.

Moreover, when a change of the folding status is detected or when the operation of inserting or extracting the hands-free headset is detected in Status 5, the controlling unit 15 just stores such a status change in the storage unit 17 but does not change the path for received voices. When a condition for terminating the data communication occurs, the controlling unit 15 transits the status back to Status 1.

In Status 1, when a condition for initiating voice communication occurs, the controlling unit 15 judges an appropriate status for transition by reading the stored folding status of the device and the stored status of hands-free headset connection out of the storage unit 17. If the hands-free headset is not connected and the device is in the folded status, then the controlling unit 15 transits the status to a main body voice communicating (with the voice-receiving receiver) status (hereinafter referred to as Status 2).

Upon transition to Status 2, the controlling unit 15 instructs the received-voice switching unit 8 to switch the path for received voices to the voice-receiving receiver 11. Status 2 refers to an ordinary status of usage; therefore, the operator can listen to voices of an opponent by putting the device close to the ear.

Meanwhile, if the hands-free headset is not connected and the device is in the unfolded status, then the controlling unit 15 transits the status to a main body voice communicating (with the amplifying loudspeaker) status (hereinafter referred to as Status 3). Upon transition to Status 3, the controlling unit 15 instructs the received-voice switching unit 8 to switch the path for received voices to the amplifying loud speaker 12. Such automatic transition to Status 3 is characteristic in the present invention.

In this status, the path for received voices is set to the amplifying loudspeaker 12. As the voices received from the opponent are amplified out of the amplifying loudspeaker 12, the user can listen to the voices of the opponent while watching the main display unit 20 or operating the main operating unit 18.

If the hands-free headset is connected, then the controlling unit 15 transits the status to a hands-free headset voice communicating status (hereinafter referred to as Status 4) irrelevant to the folding status of the device. Upon transition to Status 4, the controlling unit 15 instructs the received-voice switching unit 8 to switch the path for received voices to the hands-free headset connector 13. The reason why the received voices are not outputted to the amplifying loudspeaker 12 in spite of the unfolded status is because the operator can watch the main display unit 20 or operate the main operating unit 18 freely when the operator is using the hands-free headset.

In Status 2, when the folding status detecting unit 16 detects the unfolded status, the controlling unit 15 stores such a status change in the storage unit 17 and transits the status to Status 3. Upon transition to this status, the controlling unit 15 instructs the received-voice switching unit 8 to switch the destination of output of the analog voice signals from the voice-receiving receiver 11 to the amplifying loudspeaker 12. Simultaneously, the controlling unit 15 instructs the voice unit 7 to switch the amplification factor to be applied to the analog voice signals inputted from the demodulating unit 3 from the amplification factor for the voice-receiving receiver 11 to the amplification factor for the amplifying loudspeaker 12. In other words, the amplification factor is increased.

On the contrary, in Status 3, when the folding status detecting unit 16 detects the folded status, the controlling unit 15 stores such a status change in the storage unit 17 and transits the status to Status 2. Upon transition to this status, the controlling unit 15 instructs the received-voice switching unit 8 to switch the destination of output of the analog voice signals from the amplifying loudspeaker 12 to the voice-receiving receiver 11. Simultaneously, the controlling unit 15 instructs the voice unit 7 to switch the amplification factor to be applied to the analog voice signals inputted from the demodulating unit 3 from the amplification factor for the amplifying loudspeaker 12 to the amplification factor for the voice-receiving receiver 11. In other words, the amplification factor is decreased.

In Status 2 or Status 3, when the hands-free headset is connected, the controlling unit 15 stores such a status change in the storage unit 17 and transits the status to Status 4. Upon transition to this status, the controlling unit 15 instructs the received-voice switching unit 8 to switch the path for received voices from either the voice-receiving receiver 11 or the amplifying loudspeaker 12 to the hands-free headset connector 13.

In Status 4, when an operation of changing the folding status is detected, the controlling unit 15 just stores such a status change in the storage unit 17 but does not change the path for received voices. Moreover, in Status 4, when disconnection of the hands-free headset is detected, the controlling unit 15 stores such a status change in the storage unit 17 and simultaneously reads out the folding status of the device. The controlling unit 15 transits the status to Status 2 in the case of the folded status or to Status 3 in the case of the unfolded status. In this event, the controlling unit 15 instructs the received-voice switching unit 8 to switch the path for received voices from the hands-free headset connector 13 to either the voice-receiving receiver 11 or the amplifying loudspeaker 12 as appropriate.

When a condition for terminating the voice communication occurs in any of Status 2, Status 3 or Status 4, the controlling unit 15 transits the status back to Status 1 for standing-by. In this event, the controlling unit 15 instructs the received-voice switching unit 8 to close the path for received voices. According to a series of operations as described above, it is possible to switch the path for received voices automatically in response to operations by the operator to change the folding status of the device.

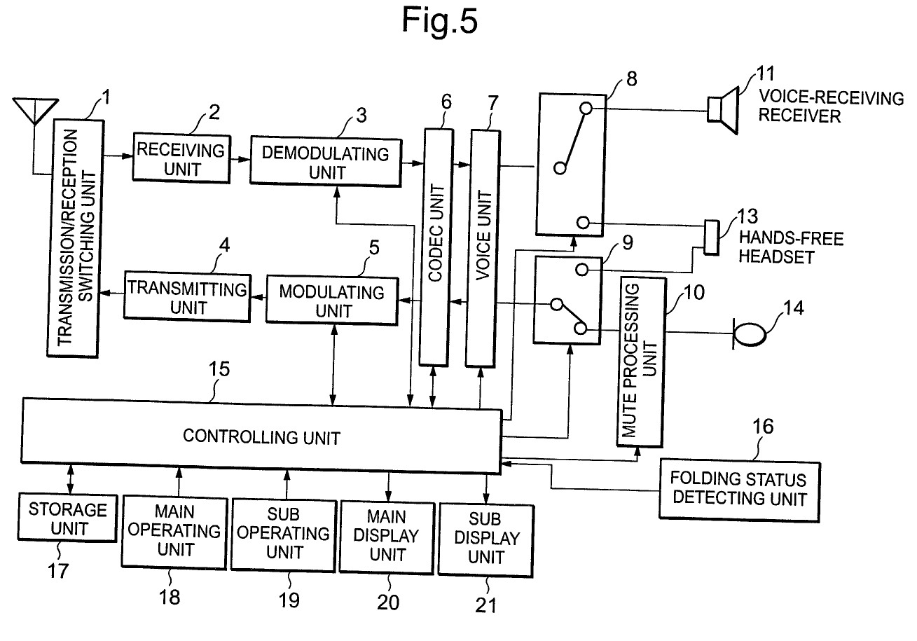

Next, description will be made regarding a second embodiment. FIG. 5 is a block diagram showing a constitution of a wireless portable terminal device according to the second embodiment. This embodiment is an example of using a voice-receiving receiver 11 which can bear sound pressure equivalent to that of an amplifying loudspeaker. In this case, the received-voice switching unit 8 should only switch between the voice-receiving receiver 11 and the hands-free headset connector 13. The controlling unit 15 designates an appropriate amplification factor to the voice unit 7 in accordance with a status of voice output. According to the embodiment, reduction in the number of components and downsizing thereof are achieved, whereby the embodiment brings about an effect of downsizing a device additionally.

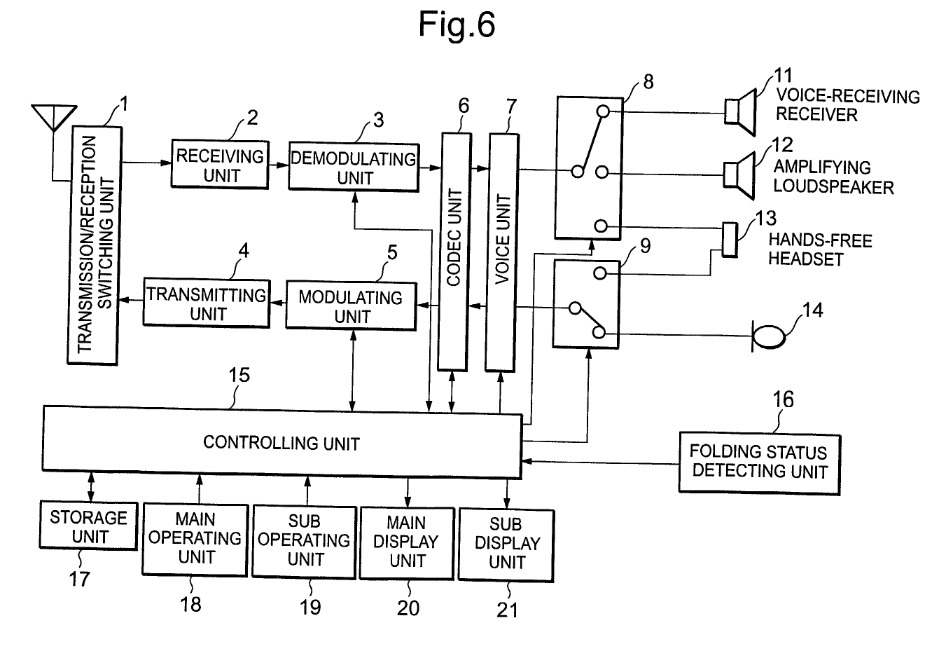

Next, description will be made regarding a third embodiment. FIG. 6 is a block diagram showing a constitution of a wireless portable terminal device according to the third embodiment. This embodiment is an example of curtailing the mute processing unit 10 in the case where the codec unit 6 possesses a function to cancel echoes for preventing the received voices from being taken into the transmitting voices. Such an additional function causes a cost rise for the codec unit 6. However, since the transmitting voices reach the opponent continuously, it is possible to use the function of amplifying the received voices according to the present invention while continuing ordinary conversation.

Needless to say, the present invention can be also adapted to a constitution including both the voice-receiving receiver 11 having the function as the amplifying loudspeaker as shown in the second embodiment and the codec unit 6 having the function of canceling echoes as shown in the third embodiment.

The method of amplifying received voices according to the present invention can be realized by causing a wireless portable terminal device to execute a program. Such a program is recorded mainly on a semiconductor recording medium and provided to the device. Otherwise, the program may be recorded on an optical recording medium or a magnetic recording medium and provided to the device. Still otherwise, the program may be downloaded to the device via a network by various file transfer protocols such as FTP and provided to the device.

As it is apparent from the foregoing description, according to the present invention, when the operator uses the wireless portable terminal device in the unfolded state to watch the display unit or perform key operations while listening to the voices of the opponent, the operations for changing the folding status of the device are detected and the received voices are automatically amplified. In this way, the present invention can provide the operator with the easiest-to-handle and the most convenient function for amplifying the received voices.

Moreover, when the operator operates the operating unit to transmit information while listening to guidance from the opponent, amplification of the received voices are carried out automatically in a flow of unfolding and operating the device. Accordingly, the present invention has an effect of reducing botheration of extracting an amplifying loudspeaker or operating an operating unit to amplify the received voices as it has been associated with the prior art.

While this invention has been described in connection with certain preferred embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

What is claimed is:

1. A wireless portable terminal device of a folding type provided with a voice-receiving receiver for outputting received voices and an amplifying loudspeaker for outputting amplified received voices, the wireless portable terminal device being designed in a manner that a casing is foldable and unfoldable, in which at least any of voice communication and an operation of an application is performed in an unfolded status, the wireless portable terminal device comprising:
folding status detecting means for detecting a folding status of the casing; and
switching means for switching a destination of output of the received voices; and
controlling means for controlling said switching means automatically in accordance with the folding status detected by the folding status detecting means.

2. The wireless portable terminal device according to claim 1, wherein the controlling means outputs the received voices to the amplifying loudspeaker when a result of detection by the folding status detecting means is the unfolded status and outputs the received voices to the voice-receiving receiver when the result of detection is the folded status.

3. A wireless portable terminal device of a folding type provided with a voice-receiving receiver, the wireless portable terminal device being designed in a manner that a casing is foldable and unfoldable, in which normal voice communication is performed in a folded status and at least any of voice communication and an operation of an application is performed in an unfolded status, the wireless portable terminal device comprising:
folding status detecting means for detecting a folding status of the casing; and
controlling means for varying an amplification factor of received analog signals automatically in accordance with the folding status detected by the folding status detecting means.

4. The wireless portable terminal device according to claim 3, wherein the controlling means sets amplification factors of the received voices to an amplification factor for voice amplification when a result of detection by the folding status detecting means is the unfolded status and to an amplification factor for voice-receiving when the result of detection is the folded status.

5. The wireless portable terminal device according to claim 1, further comprising:
a hands-free headset connector for connecting a hands-free headset; and
hands-free headset connection detecting means for detecting as to whether a hands-free headset is connected to the hands-free headset connector,
wherein the controlling means outputs the received voices to the hands-free headset connector when connection of the hands-free headset to the hands-free headset connector is detected by the hands-free headset connection detecting means.

6. The wireless portable terminal device according to claim 3, further comprising:
a hands-free headset connector for connecting a hands-free headset; and
hands-free headset connection detecting means for detecting as to whether a hands-free headset is connected to the hands-free headset connector,
wherein the controlling means outputs the received voices to the hands-free headset connector when connection of the hands-free headset to the hands-free headset connector is detected by the hands-free headset connection detecting means.

7. The wireless portable terminal device according to claim 1, further comprising:
mute processing means for canceling echoes automatically upon amplifying the received voices.

8. The wireless portable terminal device according to claim 3, further comprising:
mute processing means for canceling echoes automatically upon amplifying the received voices.

9. A method of amplifying received voices in a wireless portable terminal device of a folding type provided with a voice-receiving receiver for outputting received voices and an amplifying loudspeaker for outputting amplified received voices, the wireless portable terminal device being designed in a manner that a casing is foldable and unfoldable, in which normal voice communication is performed in a folded status and at least any of voice communication and an operation of an application is performed in an unfolded status, the method comprising:
a folding status detecting step of detecting a folding status of the casing; and
a switching step of switching a destination of output of the received voices automatically in accordance with the folding status detected by the folding status detecting step.

10. The method of amplifying received voices according to claim 9, wherein the switching step outputs the received voices to the amplifying loudspeaker when a result of detection in the folding status detecting step is the unfolded status and outputs the received voices to the voice-receiving receiver when the result of detection in the folding status detecting step is the folded status.

11. A method of amplifying received voices for a wireless portable terminal device of a folding type provided with a voice-receiving receiver, the wireless portable terminal device being designed in a manner that a casing is foldable and unfoldable, in which normal voice communication is performed in a folded status and at least any of voice communication and an operation of an application is performed in an unfolded status, the method comprising:
a folding status detecting step of detecting a folding status of the casing; and
a switching step of varying an amplification factor of received analog signals automatically in accordance with the folding status detected by the folding status detecting means.

12. The method of amplifying received voices according to claim 11, wherein the switching step switches amplification factors of the received voices to an amplification factor for voice amplification when a result of detection by the folding status detecting means is the unfolded status and to an amplification factor for voice-receiving when the result of detection is the folded status.

13. The method of amplifying received voices according to claim 9, further comprising:
a hands-free headset connection detecting step of detecting as to whether a hands-free headset is connected to a hands-free headset connector,
wherein the switching step outputs the received voices to the hands-free headset connector when connection of the hands-free headset to the hands-free headset connector is detected by the hands-free headset connection detecting step.

14. The method of amplifying received voices according to claim 11, further comprising:
a hands-free headset connection detecting step of detecting as to whether a hands-free headset is connected to a hands-free headset connector,
wherein the switching step outputs the received voices to the hands-free headset connector when connection of the hands-free headset to the hands-free headset connector is detected by the hands-free headset connection detecting step.

15. The method of amplifying received voices according to claim 9, wherein the switching step closes a path for the received voices during stand-by and during data communication.

16. The method of amplifying received voices according to claim 11, wherein the switching step closes a path for the received voices during stand-by and during data communication.

17. A program for causing to execute an operation of amplifying received voices in a wireless portable terminal device of a folding type provided with a voice-receiving receiver for outputting received voices and an amplifying loudspeaker for outputting amplified received voices, the wireless portable terminal device being designed in a manner that a casing is foldable and unfoldable, in which normal voice communication is performed in a folded status and at least any of voice communication and an operation of an application is performed in an unfolded status, the program causing the wireless portable terminal device to execute:
a folding status detecting procedure for detecting a folding status of the casing; and
a switching procedure for switching a destination of output of the received voices automatically in accordance with the folding status detected in the folding status detecting procedure.

18. The program according to claim 17, wherein the switching procedure outputs the received voices to the amplifying loudspeaker when a result of detection in the folding status detecting procedure is the unfolded status and outputs the received voices to the voice-receiving receiver when the result of detection is the folded status.

19. A program for causing to execute an operation of amplifying received voices in a wireless portable terminal device of a folding type provided with a voice-receiving receiver, the wireless portable terminal device being designed in a manner that a casing is foldable and unfoldable, in which normal voice communication is performed in a folded status and at least any of voice communication and an operation of an application is performed in an unfolded status, the program causing the wireless portable terminal device to execute:
a folding status detecting procedure for detecting a folding status of the casing; and
a switching procedure for varying an amplification factor of received analog signals automatically in accordance with the folding status detected in the folding status detecting procedure.

20. The program according to claim 19, wherein the switching procedure switches amplification factors of the received voices to an amplification factor for voice amplification when a result of detection in the folding status detecting procedure is the unfolded status and to an amplification factor for voice-receiving when the result of detection is the folded status.

21. The program according to claim 17, further causing the wireless portable terminal device to execute:
a hands-free headset connection detecting procedure for detecting as to whether a hands-free headset is connected to a hands-free headset connector,
wherein the switching procedure outputs the received voices to the hands-free headset connector when connection of the hands-free headset to the hands-free headset connector is detected in the hands-free headset connection detecting procedure.

22. The program according to claim 19, further causing the wireless portable terminal device to execute:
a hands-free headset connection detecting procedure for detecting as to whether a hands-free headset is connected to a hands-free headset connector,
wherein the switching procedure outputs the received voices to the hands-free headset connector when connection of the hands-free headset to the hands-free headset connector is detected in the hands-free headset connection detecting procedure.

23. The program according to claim 17, wherein the switching procedure closes a path for the received voices during stand-by and during data communication.

24. The program according to claim 19, wherein the switching procedure closes a path for the received voices during stand-by and during data communication.
